(19) United States
(12) Patent Application Publication
(10) Pub. No.: US 2010/0055508 A1
(43) Pub. Date: Mar. 4, 2010

(54) FUEL CELL SYSTEMS WITH WATER RECOVERY FROM FUEL CELL EFFLUENT

(75) Inventor: Curtiss Renn, Bend, OR (US)

Correspondence Address: Dascenzo Intellectual Property Law, P.C., 522 SW 5th Ave, Suite 925, Portland, OR, 97204-2126, US

(73) Assignee: IdaTech, LLC, Bend, OR (US)

(21) Appl. No.: 12/199,252

(22) Filed: Aug. 27, 2008

(51) Int. Cl. H01M 8/00; H01M 8/18

(52) U.S. Cl. 429/13; 429/20

(57) ABSTRACT

Fuel cell systems that use a desiccant to recover water from fuel cell effluent. In some embodiments, the fuel cell system may include one or more fuel cells configured to generate electrical output from a supplied fuel and an oxidant while emitting effluent. The fuel cell system also may include a desiccant disposed downstream of the one or more fuel cells. The desiccant may bind water from at least a portion of the effluent. Heat then may be generated to release bound water from the desiccant. The heat may be generated by combustion of an exhausted fuel from the fuel cells and/or by combustion catalyzed by a combustion catalyst disposed downstream of the fuel cells.

### GOVERNMENT LICENSE RIGHTS

This invention was made with Government support under W909MY-06-C-0028 awarded by the Department of the Army. The Government has certain license rights in the invention.

### FIELD OF THE DISCLOSURE

The present disclosure is directed generally to fuel cell systems, and more particularly to fuel cell systems that use a desiccant to recover water from fuel cell effluent.

### BACKGROUND OF THE DISCLOSURE

Fuel cell stacks are electrochemical devices that produce water and an electrical potential from a fuel, such as a proton source, and an oxidant. Many conventional fuel cell stacks utilize hydrogen gas as the proton source and oxygen gas, air, or oxygen-enriched air as the oxidant. Fuel cell stacks typically include many fuels cells that are fluidly and electrically coupled together between common end plates. Each fuel cell includes an anode region and a cathode region that are separated by an electrolytic barrier. In some fuel cells, the electrolytic barrier takes the form of an electrolytic membrane. Hydrogen gas is delivered to the anode region, and oxygen gas is delivered to the cathode region, typically in the form of air. Protons from the hydrogen gas are drawn through the electrolytic barrier to the cathode region, where water is formed. While protons may pass through the electrolytic barrier, electrons cannot. Instead, the electrons that are liberated from hydrogen gas travel through an external circuit to form an electric current.

Operation of a fuel cell system to produce electrical output with a fuel cell stack generally also produces a net surplus of water by reaction of fuel with oxidant. However, water also is required for efficient operation of the fuel cell system. For example, the fuel cell system may have a water-based cooling system, may need to maintain an electrolytic membrane in a hydrated condition to generate electrical output efficiently, and/or may include a fuel processor that uses water (e.g., steam) in a reaction that generates fuel for the fuel cell stack. Accordingly, to allow continuous operation, a fuel cell system without an outside water source should maintain a neutral or positive water balance by restricting loss of water to the environment. A positive water balance may be most advantageous because the excess water may be used for other purposes outside the fuel cell system, such as for drinking.

Efficient recovery of the water in a fuel cell system may be problematic. Generation of water in a fuel cell stack releases heat in the fuel cell system, which promotes water evaporation to form water vapor. The water vapor is generally entrained by, or in, a fluid stream, such as an exhaust stream from a fuel cell stack or an upstream/downstream burner(s). The fluid stream may dilute the water vapor, often substantially, with other gases (e.g., nitrogen, carbon dioxide, carbon monoxide, oxygen, methane, hydrogen, etc.). As a result, the water in the fluid stream may be too dilute for reuse in the fuel cell system as water vapor. In addition, the dilution of the water vapor with other gases may shift the mass equilibrium of water to greatly favor the gas phase. The relatively low humidity of the fluid stream (and relatively low dewpoint) thus may not permit efficient condensation of water from the fluid stream for water recovery in liquid form at, or near, ambient temperatures. Moreover, water recovery by cooling the fluid stream via heat exchange with the ambient environment may be unreliable due to diurnal, seasonal, and geographical variations in the ambient temperature. Accordingly, the fuel cell system may need to employ an active cooling mechanism that lowers the temperature of the fluid stream further for more efficient water recovery. However, the active cooling mechanism may add substantial complexity and cost to the fuel cell system, and/or operation of the active cooling mechanism may consume significant energy, thereby reducing the overall energy efficiency of the fuel cell system.

### SUMMARY OF THE DISCLOSURE

The present disclosure is directed to fuel cell systems that use a desiccant to recover water from fuel cell effluent. In some embodiments, the fuel cell system may include one or more fuel cells configured to generate electrical output from a supplied fuel and an oxidant while emitting effluent. The fuel cell system also may include a desiccant disposed downstream of the one or more fuel cells. The desiccant may bind water from at least a portion of the effluent. Heat then may be generated, such as periodically or responsive to a predetermined event, to release bound water from the desiccant. The heat may be generated by combustion of an exhausted fuel from the fuel cells and/or by combustion catalyzed by a combustion catalyst disposed downstream of the fuel cells.

### BRIEF DESCRIPTION OF THE DRAWINGS

FIG. 1 is a schematic view of selected portions of an illustrative fuel cell system for water recovery, with the fuel cell system in a binding configuration that utilizes at least one dryer to bind water from at least one effluent stream, in accordance with aspects of the present disclosure.

FIG. 2 is a schematic view of the fuel cell system of FIG. 1, with the fuel cell system in a release configuration that releases bound water from the dryer by heating at least a portion of the dryer, in accordance with aspects of the present disclosure.

FIG. 3 is a schematic view of an illustrative embodiment of the fuel cell system of FIG. 1, with the embodiment incorporating additional illustrative components, aspects, and features that may be present in the fuel cell systems of the present disclosure in any suitable combination.

FIG. 4 is a schematic view of another illustrative embodiment of the fuel cell system of FIG. 1, with the embodiment incorporating additional illustrative components, aspects, and features, including a pair of dryers for binding water, that may be present in the fuel cell systems of the present disclosure in any suitable combination.

FIG. 5 is a schematic view of selected portions of the fuel cell system of FIG. 4 in a series of illustrative binding and release configurations that may be produced during operation of the fuel cell system of FIG. 4 to recover water, in accordance with aspects of the present disclosure.

FIG. 6 is a schematic view of selected portions of the fuel cell system of FIG. 4 in a more detailed series, relative to FIG. 5, of illustrative binding and release configurations that may be produced during operation of the fuel cell system of FIG. 4 to recover water, in accordance with aspects of the present disclosure.

FIG. 7 is a schematic side cross-sectional view of an illustrative dryer that may be included in the fuel cell system of FIG. 1, in accordance with aspects of the present disclosure.

FIG. 8 is a sectional view of the dryer of FIG. 7, taken generally along line 8-8 of FIG. 7, in accordance with aspects of the present disclosure.

FIG. 9 is another side view of the dryer of FIG. 7, taken generally at the region indicated at “9” in FIG. 7, in accordance with aspects of the present disclosure.

FIG. 10 is a schematic side cross-sectional view of other illustrative dryers that may be included in the fuel cell system of FIG. 1, in accordance with aspects of the present disclosure.

FIG. 11 is a schematic view of an illustrative power delivery network that incorporates a fuel cell system according to the present disclosure.

FIG. 12 is a schematic view of selected aspects of an illustrative fuel cell, as may be used in fuel cell systems according to the present disclosure.

### DETAILED DESCRIPTION AND BEST MODE OF THE DISCLOSURE

The present disclosure is directed to fuel cell systems, including associated methods and apparatus, that use a desiccant to recover water from fuel cell effluent. A fuel cell system according to the present disclosure may include one or more fuel cells configured to generate electrical output from electrochemical reaction of a supplied fuel and a supplied oxidant while emitting effluent. The effluent may include an anode exhaust, which may provide an exhausted fuel, and a cathode exhaust, which may provide an exhausted oxidant. The fuel cell system also may include a desiccant (i.e., a drying agent) that is disposed downstream of the fuel cells, such as part of one or more dryers, and configured to receive at least a portion of the effluent, such as at least a portion of the anode exhaust, cathode exhaust, or both. The desiccant may bind water from at least a portion of the effluent, such as by adsorption, absorption, or both. Moreover, the desiccant may bind water from one or more hydrated streams (e.g., effluent streams), which may be emitted by (and/or formed downstream of and/or received from) the fuel cells and/or another source.

The fuel cell system may be configured to generate heat to release bound water from the desiccant. The stream containing the released water will be more concentrated, and in some embodiments will be substantially more concentrated, than the hydrated stream(s) from which the desiccant removed or otherwise bound water. By “more concentrated,” it is meant that water will comprise a greater amount of the stream containing the released water than the hydrated stream from which the water was bound. Accordingly, the released water may be more efficiently collected as liquid water and/or may be more effectively reused in the fuel cell system as water vapor.

The heat that releases the bound water may be generated by any suitable mechanism. In some embodiments, the heat may be generated by combustion of a fuel downstream of the fuel cells. For example, the heat may be generated, at least in part, by combustion of exhausted fuel received from the fuel cells. To provide effective heating of the desiccant, the combustion may be performed at least partly with the reactants (fuel plus oxidant) in contact with the desiccant, at least partly upstream of the desiccant (and downstream of the fuel cells), or both, among others. The combustion may react the exhausted fuel with the exhausted oxidant, with an auxiliary oxidant (i.e., oxidant not received from the fuel cells), or both. The combustion may be catalytic combustion that is catalyzed by a catalyst disposed to promote heating of the desiccant using the heat of combustion, for example, in contact with the desiccant and/or at least partly upstream of the desiccant (and downstream of the fuel cells), among others. In some embodiments, heat may be generated (and/or the combustion may be promoted by) an electrical heating assembly. The electrical heating assembly may be disposed, for example, in contact with the combustion catalyst, the desiccant, or both and/or may be disposed upstream of the desiccant, among others.

Generating heat to release bound water may be performed periodically, to provide a pulsatile release of bound water from the desiccant. In other words, water recovery may be performed cyclically with the desiccant, Periodic heating of the desiccant also may act to periodically regenerate the desiccant, by modifying the desiccant from a more hydrated to a less hydrated form, to ready the desiccant for each following cycle of binding and release.

Overall, a fuel cell system according to the present disclosure may (but is not required to) provide one or more of the following advantages: (1) the fuel cell system may be operated at or above water neutrality (e.g., with a net positive water balance), which may allow the fuel cell system to be operated continuously without the need for added water; (2) the fuel cell system may supply excess water for use outside the fuel cell system, such as to provide drinking water; and (3) the fuel cell system may recover water with improved energy efficiency.

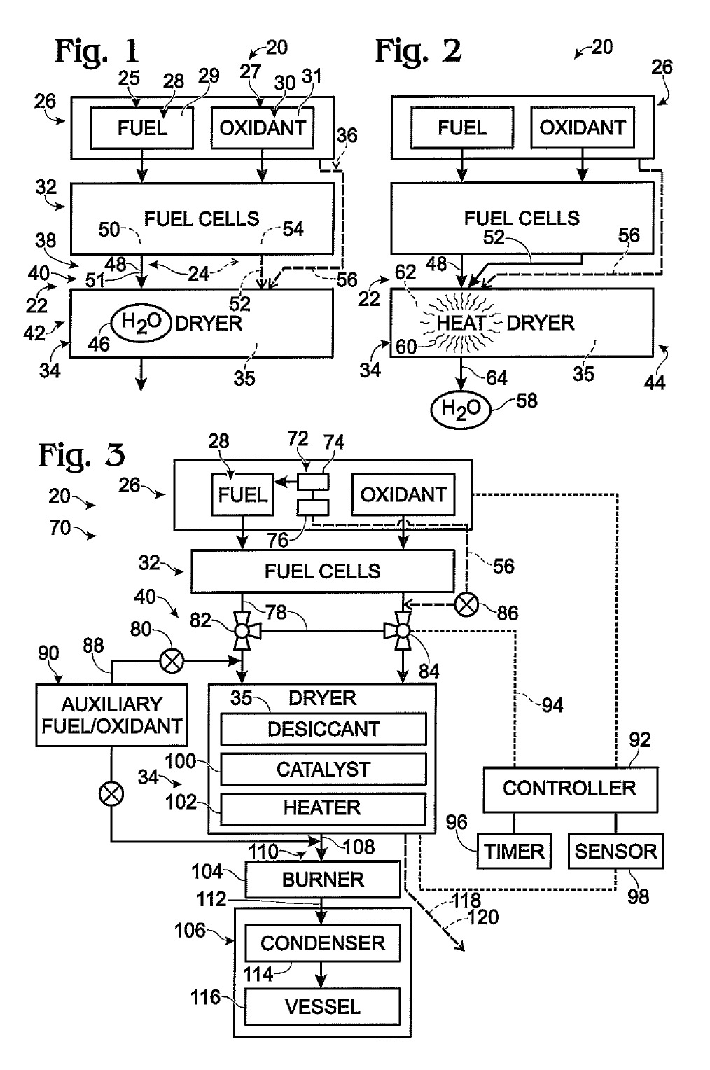

FIGS. 1 and 2 show an illustrative fuel cell system 20 that includes a water recovery system 22 for recovering water from one or more hydrated streams of fluid, such as effluent streams 24 emitted by the fuel cell system. Each hydrated stream may carry water in any suitable physical form, such as water vapor, water droplets, and/or the like. Fuel cell system 20 may include a reactant delivery system 26. As indicated in FIG. 1, the reactant delivery system may include a fuel source, or fuel supply, 25 that supplies at least one supplied fuel 28 (e.g., hydrogen 29 and/or a hydrocarbon or alcohol) and, optionally, an oxidant source, or oxygen supply, 27 that supplies at least one oxidant 30 (e.g., oxygen gas 31 and/or air). The fuel and oxygen may be supplied to one or more fuel cells 32 (e.g., a plurality of fuel cells disposed in a fuel cell stack) for generation of electrical output by the fuel cells. Although water recovery system 22 is described here in the context of a fuel cell system, the water recovery system described also or alternatively may be used to recover water in any other system that generates one or more hydrated streams.

The fuel cell system also may include at least one dryer 34 that is fluidly coupled to the fuel cells. The term “fluidly coupled,” as used herein, means a connection that disposes structures in fluid communication (and/or permits adjustable fluid communication) and thus denotes a connection that establishes or defines one or more enclosed fluid flow paths between the structures. Dryer 34 may include at least one desiccant 35 (also or alternatively termed a drying agent) to bind water and may be configured to receive at least a portion (e.g., at least one of effluent streams 24) of effluent 36 emitted by the reactant delivery system 26 and/or at least a portion of effluent 38 emitted by the fuel cells 32. In other words, the dryer(s) may be disposed downstream of the reactant delivery system and/or fuel cells.

The terms “upstream” and “downstream,” as used herein, describe relative positions along a predefined fluid flow path(s) fed by a source and/or the order of arrival of fluid flowing from the source along the flow path(s), with a downstream structure or position being farther along the fluid flow path(s) from the source and receiving fluid from the upstream structure. For example, in fuel cell system 20, fuel cells 32 are downstream of reactant delivery system 26 and upstream of dryer 34.

The term “effluent,” as used herein, describes any waste or exhaust that results from a process(es) and/or a chemical reaction(s) and/or that is emitted by (e.g., flows from) a structure in which the process(es) and/or chemical reaction(s) occurred and/or is occurring. The term “effluent” thus may be used interchangeably with the terms “waste” and “exhaust.” The effluent may be in any suitable form, for example, gaseous effluent, liquid effluent, solid (e.g., particulate) effluent, and/or a combination thereof among others.

Fuel cell system 20, and particularly dryer 34 and a connected conduit assembly 40, may be disposed in distinct configurations to enable water recovery by the fuel cell system: a binding configuration 42 (also termed a sorbing configuration or concentrating configuration) in which water is bound (sorbed) by the dryer (FIG. 1) and a release configuration 44 (also termed a desorbing configuration or unbinding configuration) in which water is released (desorbed) from the dryer (FIG. 2).

The terms “bind” and “sorb,” as used herein, mean binding and/or retaining water vapor and/or liquid water by any process including adsorption absorption, chemical bonding, or a combination thereof, among others. Accordingly, the terms “release” and “desorb,” as used herein, mean unbinding or freeing of bound (sorbed) water (e.g., as water vapor and/or in liquid form). The terms “desiccant” and “drying agent,” as used herein, mean any substance, material, and/or composition that is capable of binding/sorbing water from (also referred to as “drying”) a hydrated stream that contacts the desiccant, to remove water from the hydrated stream (and thus dry the stream).

Binding water may be performed by a desiccant 35 having any suitable structure. Illustrative, non-exclusive types of desiccants include molecular sieves (e.g., zeolite), hygroscopic salts (e.g., calcium chloride, calcium sulfate, lithium chloride, magnesium sulfate, potassium carbonate, etc.), water absorbent liquids, and/or the like. The desiccant may be primarily, or at least mostly, a solid desiccant, that is, a desiccant having a solid phase, which may remain solid or may liquefy or become a gel upon sorption of water. Alternatively, or in addition, the desiccant may be primarily, or at least mostly, a liquid desiccant. If provided as a solid or a gel, the desiccant may be provided by any suitable number of desiccant elements (e.g., desiccant particles) that include the desiccant, and may have any suitable shape and size.

FIG. 1 schematically illustrates bound water 46 that has been restrained and concentrated by desiccant 35 in dryer 34 from at least a portion of effluent 38, such as at least a portion of an anode exhaust or anode exhaust stream 48 formed from effluent 38. The anode exhaust stream (also termed a fuel effluent stream) may flow from an anode 50 (also termed an anode region(s)) of the fuel cells and thus may be described as an anode exhaust stream that includes at least one exhausted fuel 51. The exhausted fuel may be in the same chemical form as the supplied fuel 28 delivered to the fuel cells by the reactant delivery system (i.e., the exhausted fuel may be supplied fuel that has flowed through the fuel cells unreacted), may be a fuel that has a chemical structure distinct (i.e., different) from the supplied fuel (e.g., may be derived from the supplied fuel by chemical (e.g., electrochemical) reaction, such as in the fuel cells), or may be a combination thereof among others. Illustrative, non-limiting examples of an exhausted fuel include hydrogen gas, carbon monoxide, a hydrocarbon, an alcohol, and/or the like.

Any suitable effluent stream and/or hydrated stream may be modified from a more hydrated condition to a less hydrated condition by passing through dryer 34, which binds water from the stream. For example, in other binding configurations, dryer 34 may alternatively or additionally bind water from at least one other effluent stream 24. Dryer 34 thus may bind water from cathode exhaust or at least one cathode exhaust stream 52 formed from effluent 38 The cathode exhaust stream (also termed an oxidant effluent stream) may flow from a cathode 54 or cathode region(s) of the fuel cells as cathode exhaust and thus may be described as cathode exhaust flowing as one or more cathode exhaust streams, which may include an oxidant. Alternatively, or in addition, dryer 34 may bind water from at least one exhaust stream 56 emitted by reactant delivery system 26. Exhaust stream 561 which may form at least a part of effluent 36, may include an oxidant (e.g., oxygen gas or air) and/or a reductant (e.g., a fuel with the chemical structure of supplied fuel 28).

FIG. 2 schematically illustrates released water 58 that has been freed from dryer 34 by exposing desiccant 35 to heat 60. The desiccant may be heated by any suitable mechanism or combination of mechanisms that generate heat internally (i.e., with a heating agent disposed in the dryer and/or in fluid communication with the desiccant) and/or externally (i.e., with a heating agent disposed outside the dryer and/or in fluid isolation from the desiccant). For example, in FIG. 2, the desiccant is heated internally, at least in part, by heat released from a chemical reaction performed proximate to the desiccant and/or with reactants disposed upstream of and/or in contact with the desiccant. The chemical reaction may be combustion. Accordingly, the desiccant may be heated by introducing a combustible mixture 62 of a fuel and an oxidant into dryer 34 under conditions that promote combustion of the mixture to release heat. The combustible mixture may be formed by combining anode exhaust stream 48 with an oxidant provided by cathode exhaust stream 52, exhaust stream 56 from the reactant delivery system, an auxiliary oxidant stream that is from a source other than the reactant delivery system and fuel cells, or any suitable combination thereof. Furthermore, fuel for the combustible mixture may be provided at least in part and/or at least substantially exclusively by the anode exhaust stream, and/or may be supplemented with or replaced by a fuel stream from another fuel source, such as a fuel stream from the reactant delivery system 26 that bypasses the fuel cells.

The term “combustion,” as used herein, means a rapid chemical process in which a fuel (i.e., a reductant) reacts with an oxidant, typically oxygen gas, to produce heat and, optionally, light. Combustion thus is any suitable exothermic oxidation-reduction reaction. Combustion may include catalytic combustion performed in the presence of a combustion catalyst, flame combustion in which a flame is produced, or a combination thereof, among others. For example, catalytic combustion may occur outside the critical flame concentration of the fuel and thus may proceed without the production of a flame. The term “combustible mixture,” as used herein, means any mixture of fuel and oxidant that is configured to undergo combustion.

The water sorption represented by FIG. 1 and the water desorption represented by FIG. 2 may be performed repeatedly in an alternating fashion (i.e., cyclically as a plurality of cycles) to provide periodic release of water from at least one dryer. In other words, the release of water from the dryer as part of at least one outflow stream 64 may be in a pulsatile fashion that provides a periodically recurring alternate increase and decrease in the mass and/or concentration of water disposed in the outflow stream. The released water may be carried by the outflow stream as water vapor, liquid water (e.g., as droplets), or a combination thereof, among others.

The pulsatile release of water may have any suitable periodicity. For example, the pulsatile release may have a regular periodicity or an irregular periodicity. Regular periodicity generally means that the durations of the sorption-desorption cycles are uniform (or approximately the same), and irregular periodicity means that the sorption-desorption cycles have nonuniform (i.e., different) durations. If the periodicity is irregular, the durations of the sorption phases and/or the desorption phases of the cycles may be nonuniform.

Fuel cell system 20 may be configured or otherwise used to perform a method of recovering water in a fuel cell system. The method may include the following steps, performed in any suitable combination and in any suitable order. Effluent may be emitted from a fuel cell stack that is producing electrical output from a fuel and an oxidant. The effluent may be emitted as one or more effluent streams, such as at least one anode effluent stream including a fuel and/or at least one cathode effluent stream, which may include an oxidant. Water may be concentrated from at least a portion of the effluent by sorbing (i.e., binding) the water with a desiccant. Bound water may be released from the desiccant in a pulsatile fashion by periodically heating the desiccant to desorb water from the desiccant. Alternatively, or in addition, the bound water may be released from the desiccant with heat generated by combustion of an exhausted fuel provided by the effluent (e.g., exhausted fuel disposed in at least one stream forming at least a part of the effluent, such as anode effluent). The water that is released may be processed. For example, at least a portion of the water that is released may be collected as liquid water. The liquid water may be reused in the fuel cell system and/or may be used outside the fuel cell system, such as for drinking. Alternatively, or in addition, at least a portion of the concentrated water that is released may be reused in the fuel cell system, such as in the form of water vapor disposed in a fluid stream. Illustrative reuses of the water vapor include fuel processing, hydration of fuel cells, hydration of reactants, cooling of fuel cells, or a combination thereof, among others. Collectively, the steps of the method may provide the fuel cell system with at least a neutral (i.e., non-negative) water balance or with a positive water balance in which the fuel cell system is a net producer of water.

Any of the methods disclosed herein may be performed under control of a program run, or executed, by a controller. Accordingly, the method may be embodied in computer program code carrying instructions and stored on tangible computer-readable storage media (e.g., hard drives, compact discs, floppy disks, flash drives, etc.). In particular, when the computer program code is loaded and executed by the controller, the controller becomes an apparatus for practicing the method in conjunction with other portions of a fuel cell system. In some embodiments, the computer program code may be received from another source via data transmission, such as fiber optics, electromagnetic radiation, electrical conductors (e.g., wires, cables, etc.), or the like.

At 70, FIG. 3 shows an illustrative, non-exclusive example of fuel cell system 20. Fuel cell systems 20 according to the present disclosure may include any suitable combination of the illustrative components, aspects, and features shown and described below for fuel cell system 70 and shown and described elsewhere in the present disclosure for other illustrative embodiments of such fuel cell systems.

Reactant delivery system 26 of fuel cell system 70 may include a fuel processor 72 that generates fuel 28 from at least one feedstock and/or feed stream. In some examples, fuel processor 72 may include a reformer 74 and a heat generating assembly, such as a burner 76. The reformer may, for example, produce a supplied fuel (for use by fuel cells 32) from a feedstock (e.g., a hydrocarbon or alcohol, among others) and water (e.g., in a steam reformer) or from a feedstock, air, and water (e.g., in an autothermal reformer), among others. In some examples, exhaust stream 56 may be emitted by burner 76. A “burner,” as used herein, may be a flame burner, a catalytic bed, and/or the like.

Conduit assembly 40 may adjustably direct any suitable number of fluid streams to each dryer 34. For example, conduit assembly 40 may direct effluent streams from reactant delivery system 26 and/or fuel cells 32 to at least one dryer 34, to provide adjustable fluid coupling between reactant delivery system 26, fuel cells 32, and/or dryer 34. The conduit assembly may include one or more conduits 78 for carrying fluid streams and a valve assembly including one or more flow-management devices, such as valves 80-86, that regulate flow of the fluid streams through the conduits. More generally, each fluid stream in the fuel cell system may flow through and/or be carried by at least one conduit that contains and/or directs the fluid stream.

The conduit assembly may be adjustable to determine which stream or combination of streams flows to a particular dryer at a given time. Accordingly, the conduit assembly may allow any suitable combination of fluid streams to be mixed upstream of the dryer (before the fluid streams enter the dryer) and/or upstream of at least a portion of the desiccant. In the present, non-limiting illustration, valves 82, 84 may be adjusted to determine whether anode exhaust stream 48, cathode exhaust stream 52, separate streams 48 and 52, or a mixture of streams 48 and 52 enters a particular dryer 34. As another example, valve 80 of conduit assembly 40 may be adjusted to determine whether an auxiliary oxidant stream 88 from an auxiliary oxidant (and/or fuel) source 90 is combined with anode exhaust stream 48 and/or one or more oxidant exhaust streams 52 and/or 56 before the streams enter the dryer. An auxiliary air source, such as auxiliary oxidant source 90, may be used when the exhaust stream(s) from fuel cells 32 and/or reactant delivery system 26 is too deficient in oxygen gas to provide efficient combustion of fuel.

Each valve may (but is not required to be) controlled by a controller 92, which may be operatively connected to (i.e., in communication with) each valve to control adjustment of the valve. However, FIG. 3 shows a connection 94 of controller 92 to only valve 84, to simplify the presentation. Controller 92 may control adjustment of the valves according to any suitable criteria. For example, controller 92 also may be in communication with a timer 96 in order to receive time data from the timer. Accordingly, to achieve periodic binding and release of water by the dryer, the controller may adjust the valves based on a predetermined schedule and/or predetermined time intervals. Alternatively, or in addition, the controller may be connected to (in communication with) one or more sensors 98. Each sensor may be configured to measure any suitable parameter, such as humidity, temperature, flow rate, flow volume, recovered amount of water, electrical output of the fuel cells, or the like. The sensor may measure the parameter at any suitable position relative to the fuel cell system. For example, the parameter may be measured between reactant delivery system 26 and fuel cells 32, within or proximate to fuel cells 32, within or proximate to conduit assembly 40, within or proximate to dryer 34, or downstream of the dryer(s), among others. In some embodiments, signals from at least one humidity sensor and/or flow sensor may be used by a controller to determine how binding water to, and/or release of water from, a dryer is conducted. For example, the signals may be used to determine when binding water to a dryer is stopped (e.g., before the dryer becomes saturated with water and becomes unable to bind water efficiently), when releasing water from a dryer is started, when releasing water from a dryer is stopped (e.g., when the humidity of the outflow stream drops below a threshold level), and/or the like. The controller and/or sensor may be described as being configured to detect a predetermined, or triggering, event. Illustrative, non-exclusive examples of such events include the passage of a predetermined period of time, a predetermined maximum or minimum humidity level, temperature, flow rate, demand for water, weight, electrical output, etc.

Dryer(s) 34 may include any suitable combination of at least one desiccant 35, at least one catalyst 100, and one or more heaters 102. Catalyst 100 may be, or include, any substance or composition that catalyzes an oxidation-reduction reaction of a reductant (i.e., a fuel) with an oxidant, generally by reducing the activation energy of the reaction without being consumed substantially by the reaction. The catalyst, also termed a combustion catalyst, may (but is not required to) include a precious metal (e.g., platinum, palladium, rhodium, and/or ruthenium, among others). The catalyst also or alternatively may include a promoter (e.g., an oxide such as cerium oxide, manganese oxide, etc.). The catalyst may be coupled to a substrate that acts as a support for the catalyst. Illustrative substrates include alumina, silica, mullite, cordierite, or a metal (e.g., aluminum, Fecralloy®, etc.). The substrate (e.g., a metal) may be heat conductive, which may distribute heat more uniformly to the catalyst and/or desiccant.

The use of a catalyst in the dryers disclosed herein may have substantial advantages. For example, the catalyst may permit catalytic combustion of fuel to be conducted with a concentration of fuel that is outside of the fuel concentration range that sustains open flame combustion (e.g., in a non-limiting example of less than 4% or greater than 70% hydrogen gas), provided there is sufficient oxidant. Alternatively, or in addition, the catalyst may permit combustion of fuel with less applied heat (i.e., at a lower temperature), more rapidly, and/or more efficiently, among others.

Dryer 34 may be fluidly coupled to a burner 104 (e.g., a tail gas burner) and/or a water collection assembly 106, also termed a phase separation assembly, disposed downstream of the dryer. Burner 104 may be configured to promote combustion, such as catalytic combustion of fuel received from dryer 34. Burner 104 thus may be a catalytic bed that includes a combustion catalyst. Combustion in burner 104 also or alternatively may be promoted by mixing an effluent stream 108 from dryer 34 with oxidant from auxiliary oxidant source 90, as shown at 110. The tail gas burner may function to reduce the concentration of exhausted fuel, to allow an exhaust stream to be vented more safely to the environment, with reduced risk of toxicity, a fire, and/or an explosion. However, in some embodiments, exhaust from a dryer may be vented without treatment by burner 104.

Water collection assembly 106 may be configured to collect water in liquid form downstream of dryer 34, for example, from dryer effluent stream 108 that is received directly or that is modified by burner 104 to create a burner exhaust stream 112. Assembly 106 may (but is not required to) include a heat exchange assembly or condenser assembly 114 that cools stream 108 and/or stream 112. Assembly 106 also may include a liquid storage structure, such as a vessel 116 (which may additionally or alternatively be referred to as a container), that is configured to receive and store liquid water produced by action of the condenser assembly and/or that condenses spontaneously. The vessel thus may collect water released by desorption from the dryer 34 and/or water generated by combustion with burner 104, among others. The water that is collected in vessel 116 may be (but is not required to be) in a purified form (e.g., distilled water) and thus may be suitable for drinking (potable water) or for any application utilizing purified water.

Desorbed water from dryer 34 alternatively or in addition may be routed from the dryer (before or after passing through burner 104) using a recirculation assembly that includes at least one recirculation conduit 118 to carry the desorbed water in a humidified stream or fluid stream 120 for reuse in the fuel cell system as water vapor and/or liquid water.

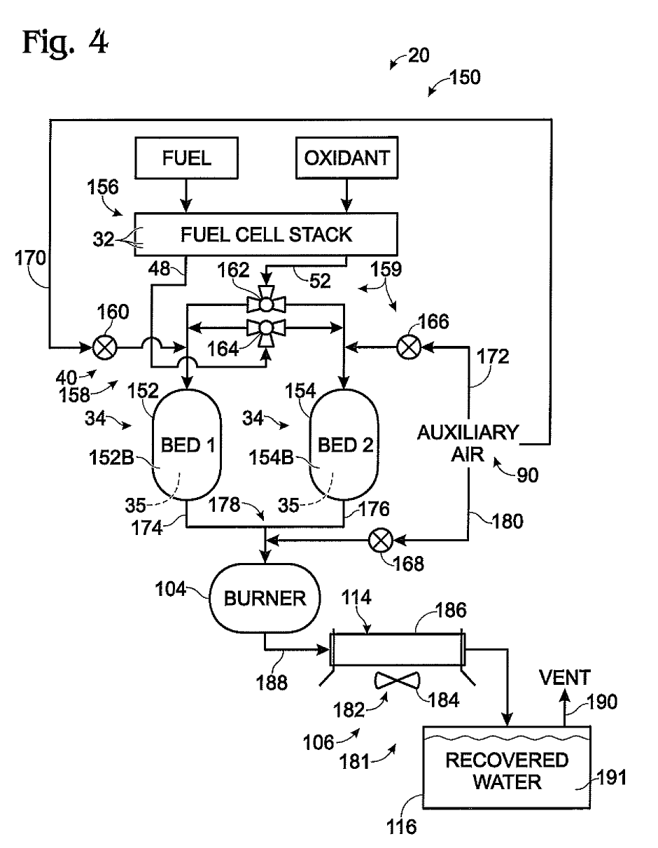

FIG. 4 shows, at 150, another illustrative, non-exclusive example of a fuel cell system 20 according to the present disclosure. Fuel cell system 20 may include any suitable combination of the illustrative components, aspects, and features shown and described below for fuel cell system 150 and shown and described elsewhere in the present disclosure for other illustrative embodiments of fuel cell systems with water recovery.

Fuel cell system 150 may employ two or more dryers, including a pair of dryers: a first dryer 152 and a second dryer 154. Each dryer may provide a respective desiccant bed 152B, 154B formed at least in part by desiccant 35. Dryers 152, 154 may be fluidly coupled to a fuel cell stack 156 (including fuel cells 32) via an illustrative embodiment 158 of conduit assembly 40. Conduit assembly 158 may include a valve assembly 159 with a plurality of valves 160-168. Of these, valves 160-166 may be adjustable to determine how and when anode exhaust stream 48, cathode exhaust stream 52, and auxiliary oxidant streams 170, 172 are combined upstream of dryers 152, 154 (and/or upstream of at least a portion of desiccant beds 152B and/or 154B), and to which dryer(s) the combined (or uncombined) streams are directed. For example, valves 160-166 may be adjusted to direct at least a portion of stream 48 alone, stream 48 plus stream 52, stream 52 alone, stream 48 plus stream 170, or stream 48 plus stream 170 plus stream 52, among others, to either the first dryer 152, to the second dryer 154, or to both dryers at the same time. In other words, the valves may be adjusted to direct exhausted fuel, exhausted oxidant, or a mixture of exhausted fuel and exhausted oxidant to one or both of the dryers.

Dryers 152, 154 may emit respective outflow streams 174, 176, which may (or may not) be combined, indicated at 178, upstream of tail gas burner 104, if both dryers are emitting fluid streams at the same time. Furthermore, auxiliary air source 90 may supply an oxidant stream 180, with flow controlled by valve 168. Oxidant stream 180 optionally may be combined with one or both of outflow streams 174, 176 upstream of tail gas burner 104. In the present, non-limiting embodiment, dryers 152, 154 are in fluid communication downstream of the dryers via conduits. In other embodiments, the dryers may be in fluid isolation from one another downstream of the dryers or may be disposed in adjustable fluid communication by a valve assembly of one or more valves.

Fuel cell system 150 may include a water collection assembly 106, with an illustrative, non-exclusive example indicated at 181. Water collection assembly 181 may include a condenser assembly 114 that includes a convective cooling assembly 182, such as a fan assembly 184 or other air source, that drives air against a condenser conduit 186 to cool a burner exhaust stream 188 flowing through conduit 186. The burner exhaust stream then may flow into vessel 116 and out vent 190, to exhaust gases while liquid water 191 is retained in vessel 116.

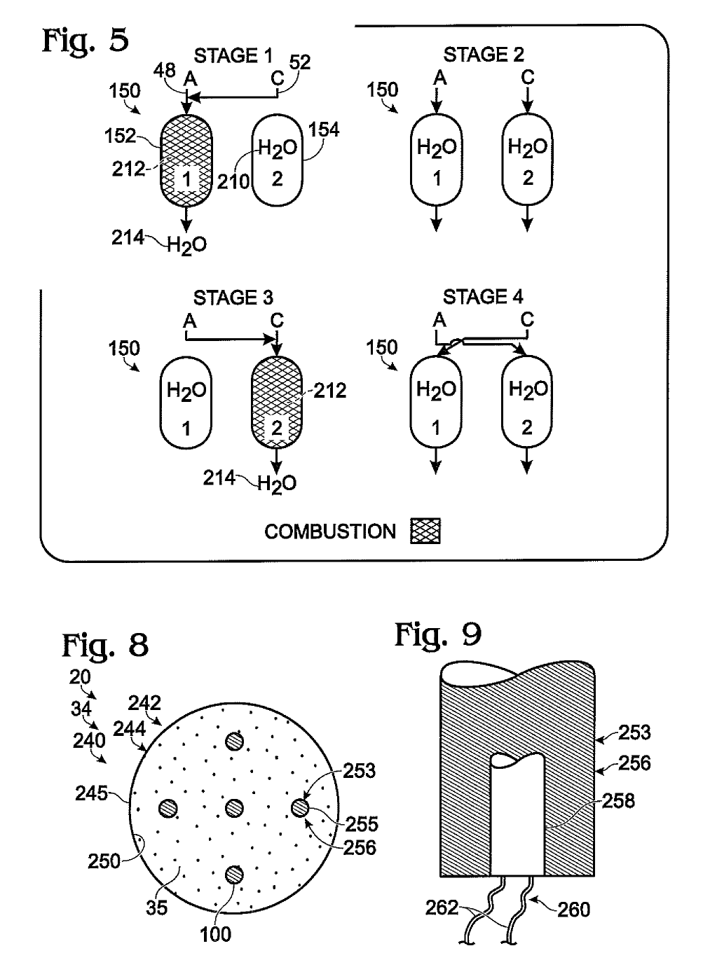

FIG. 5 shows a series of illustrative binding and release configurations that may be produced during operation of fuel cell system 150 to recover water, at least in part using dryers 152, 154 of the system. (The dryers also are labeled respectively as “1” and “2” inside their schematic representations). The two binding configurations (Stages 2 and 4) and two release configurations (Stages 1 and 3) shown here may define four distinct stages (Stages 1-4) of a repeated cycle. The stages may be performed repeatedly in the numerical order shown or may be performed in distinct orders during distinct cycles. In some examples, water recovery may be performed as only two stages, with both dryers in a binding configuration at the same time and both dryers in a release configuration at the same time. In some examples, one of the dryers may be part of a binding configuration while the other dryer is part of a release configuration.

In each stage shown in FIG. 5, anode exhaust stream 48 and cathode exhaust stream 52 flow, respectively, from an anode (“A”) and a cathode (“C”) of the fuel cell stack either to distinct dryers or to the same dryer. In the present illustration, streams 48 and 52 flow to distinct dryers in Stages 2 and 4 and flow to the same dryer, either dryer 152 or dryer 154, in each of Stages 1 and 3. When each exhaust stream flows to a distinct dryer, the dryer binds water from the stream to produce bound water 210 (“H₂O”). In contrast, when both exhaust streams flow to the same dryer, fuel and oxidant supplied by the combined streams may introduce a combustible mixture 212 into the dryer, which results in combustion in the dryer (indicated as a cross-hatched area within the dryer). The combustion releases heat, which heats the dryer, and particularly a drying agent to which water 210 is bound, to produce released water 214.

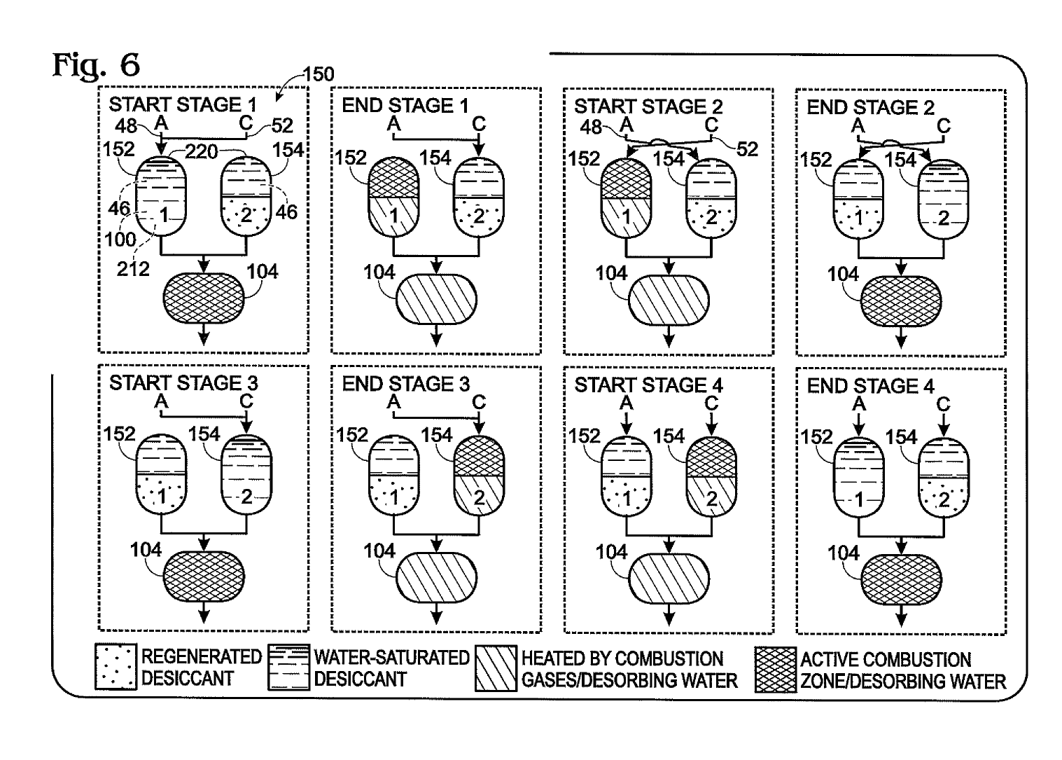

FIG. 6 shows a more detailed series (relative to FIG. 5) of illustrative binding and release configurations that may be produced during operation of fuel cell system 150 to recover water, at least in part using dryers 152, 154 of the system. FIG. 6 refers to the same Stages 1-4 as FIG. 5, but presents two sequential panels for each Stage, namely, a first panel representing the start of each stage and a second panel representing the end of each stage. Furthermore, dryers 152, 154 and burner 104 are marked in FIG. 6 to indicate where (1) the dryers are regenerated (i.e., dry and/or ready to bind water), (2) the dryers are holding bound water (e.g., where each dryer is saturated with water), (3) heating is occurring predominantly or exclusively by heat transfer from heated gas (e.g., gases heated by combustion), and, for the dryers, water desorption is occurring, and (4) active combustion is occurring (and, for the dryers, water desorption is occurring).

The start of Stage 1 may coincide with conditions at the end of Stage 4. The tail gas burner may be heated by internal combustion occurring within the burner. First dryer 152 may be at or near water-holding capacity (saturation), and the second dryer 154 may be partially saturated (e.g., with more bound water 46 disposed closer to an inlet 220 of the dryer). At the beginning of Stage 1, anode exhaust and/or an anode exhaust stream 48 and cathode exhaust and/or a cathode exhaust stream 52 (and/or oxidizing gases in general) may be combined near inlet 220 of dryer 152 to form combustible mixture 212 (and/or a stream thereof) that flows into dryer 152. Upon contact with combustion catalyst 100 disposed in dryer 152, the mixture may react to form combustion products, for example, water and carbon dioxide, while liberating heat from the reaction. A benefit of the use of internal combustion may be that water formed from internal combustion also may be available for recovery whereas an external burner produces water from the combustion process that may be more difficult to recover.

At the end of Stage 1, first dryer 152 may have been heated throughout to remove sorbed water. During Stage 1, all of the combustion may take place in first dryer 152. Little or no combustion may occur in tail gas burner 104, which may be heated from the hot combustion gases and water vapor received from first dryer 152. Also during Stage 1, second dryer 154 may be idle (e.g., not receiving any fluid stream and/or not receiving any fluid stream from fuel cells 32, among others). Given appropriate geometry, there may be no need to isolate second dryer 154. As such, there may be no valves between the dryers 152, 154 and burner 104.

At the beginning of Stage 2, valve(s) may be adjusted to maintain flow of cathode exhaust stream 52 through first dryer 152 and to switch flow of anode exhaust stream 48 to second dryer 154. First dryer 152 may still be hot from the combustion process, and thus this dryer may need to be cooled down to effectively sorb water vapor. Accordingly, the desiccant in dryer 152 may be cooled by an external heat transfer using a fan or other fluid drive assembly or by internal heat transfer to cathode exhaust stream 52, which may be modestly cool (e.g., 50-60° C.). As the first dryer 152 sorbs water vapor, the process of sorption may be exothermic and thus may generate heat. As such, passive cooling may be augmented with active cooling of first dryer 152, either externally or internally. Cathode exhaust stream 52, which may be depleted of water, then may exit first dryer 152 and may be combined with the anode exhaust stream 48 from second dryer 154, for catalytic combustion in the tail gas burner 104. Auxiliary air may be added to the burner 104 to complete combustion if sufficient oxygen is not available from cathode exhaust stream 52. Effluent from tail gas burner 104 then may be cooled, and liquid water may be removed by phase separation assembly 106 (see FIG. 4). With proper adjustment of oxidant streams (cathode exhaust, fuel processor exhaust, and/or auxiliary air), the vent gas from the phase separation assembly may be at least substantially devoid of flammable gases, including hydrogen gas and carbon monoxide. At the end of Stage 2, first dryer 152 may be cooled and partially saturated with water. Second dryer 154 may be saturated with water, and tail gas burner 104 may be hot from catalytic combustion.

At the beginning of Stage 3, valve(s) may be adjusted to direct both the anode and cathode exhaust streams to second dryer 154, and first dryer 152 may be isolated from gas flow upstream of the first dryer. Combustion then may occur as in Stage 1, except in second dryer 154. The end of Stage 3 may be the same as the end of Stage 1 except that the active dryer is the second dryer 154.

At the beginning of Stage 4, valve(s) may be adjusted to separate the anode and cathode exhaust streams, and to direct these exhaust streams to respective dryers 154, 152, which is inverse of the configuration of Stage 2. At the end of Stage 4, first dryer 152 may be at least mostly saturated with water, second dryer 154 may be partially saturated, and tail gas burner 104 may be hot from combustion in the burner.

The system then may return to Stage 1 to repeat the cycle. In some embodiments, water recovery may be performed with an abbreviated cycle that uses only Stages 1 and 2 by introducing a mixture of anode and cathode exhaust streams into both of the dryers in Stage 1. However, including Stages 3 and 4 may allow each dryer to be exposed to substantially the same conditions over time, that is, alternating between binding water from the anode exhaust stream and the cathode exhaust stream. The benefit of this mirrored approach may be that the two dryers should age or perform similarly over time since neither dryer is preferentially exposed to anode or cathode exhaust.

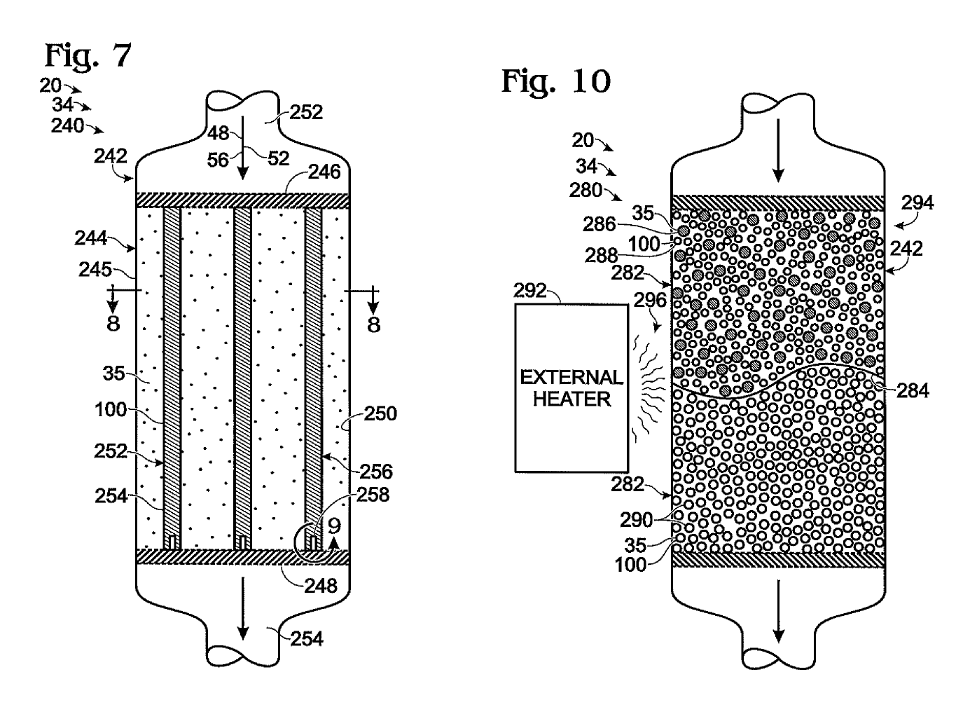

At 240, FIGS. 7 and 8 show respective side and sectional views of an illustrative, non-exclusive example of a dryer 34 that may be included in fuel cell system 20 according to the present disclosure. Dryer 240 may include a housing 242 that provides one or more side walls 244 forming a conduit 245 that encloses the dryer laterally. Dryer 240 also may include at least one end wall, such as opposing end walls 246, 248 that collectively, along with side walls 244, define a dryer compartment or dryer chamber 250 that receives fluid from the fuel cells. Dryer 240 further may include an inlet 252 configured to receive one or more hydrated streams, such as anode exhaust stream 48, cathode exhaust stream 52, and/or burner exhaust stream 56, among others, and also may include an outlet 254 through which dryer exhaust may flow. Fluid streams may flow through the dryer between inlet 252 and outlet 254 and thus end walls 246, 248 may have a flow-permissive structure, such as a porous configuration, that permits fluid flow through the dryer while retaining dryer contents in chamber 250.

Dryer chamber 250 may hold any suitable contents, including desiccant 35 and combustion catalyst 100. The desiccant and the combustion catalyst may be intermixed (e.g., in contact with one another) or may be segregated (e.g., spaced) within the dryer. If segregated, the combustion catalyst may be disposed upstream of the desiccant, downstream of the desiccant, or both upstream and downstream of the desiccant. Placement of the combustion catalyst upstream of the desiccant or in contact with the desiccant may be much more efficient for combustion heat transfer to the desiccant than placement of the combustion catalyst downstream of the desiccant, since heat generated downstream of the desiccant will be carried away from the dryer by fluid flow.

The combustion catalyst may be supported by one or more substrate members 253, such as wires 255. Combustion catalyst 100 may be disposed on an exterior surface of the substrate members and/or may be internal to the substrate members.

The substrate members also may be described as heat-transfer members, which may or may not support a combustion catalyst. A heat-transfer member may be formed of a heat-conductive material, such as metal, to promote heat transfer within the dryer. For example, each heat-transfer member may be a metal fiber, metal wire, metal mesh, metal foil, metal shot, or other metal member designed to distribute heat to the desiccant in the dryer. Any suitable metal may be used to form a heat-transfer member including aluminum, copper, steel, or the like. A substrate member/heat-transfer member may be elongate, such as extending lengthwise in chamber 250, although other orientations and positions may be utilized.

Dryer 250 may include one or more heater assemblies 256 (see FIGS. 7 and 9). Each heater assembly may, for example, be disposed at least partly in chamber 250. The heater assembly 256 optionally may include at least one substrate member/heat-transfer member 253. For example, in the present non-limiting illustration, a heating element 258 of the heater assembly is attached to heat-transfer member 253, to provide heat transfer from the heating element to the heat transfer member. Heating element 258 may be disposed in contact with heat-transfer member 253 to provide conductive heat transfer. For example, in dryer 240, heating element 258 is embedded in an end of heat-transfer member 253. The heater assembly may or may not be in contact with desiccant 35 and/or combustion catalyst 100.

Heater assembly 256, and particularly heating element 258, may be configured to be energized electrically (i.e., supplied with electrical power), which also may be termed as being actuated, and thus may be described as an electrical heater assembly and an electrical heating element. The heating element may include one or more electrical conduits 260, such as wires 262, that conduct an electric current from a power source to a body of the heating element. In illustrative embodiments, the body of the heating element may be or include a resistor heater or a thermoelectric heater among others.

FIG. 10 at 280 shows a side view of another illustrative, non-exclusive example of a dryer 34 that may be included in fuel cell system 20 according to the present disclosure. Dryer 280 may hold a plurality of particles 282 that include desiccant 35 and/or combustion catalyst 100. The particles may have various configurations, with two potential particle configurations schematically illustrated in FIG. 10 on opposed sides of line 284. In the upper configuration (i.e., graphically represented above line 284), desiccant 35 and combustion catalyst 100 are distributed as separate, or discrete, particles: desiccant 35 is provided by desiccant particles 286 and combustion catalyst 100 by distinct catalyst particles 288. In contrast, in the lower configuration (i.e., graphically represented below line 284), desiccant 35 and combustion catalyst 100 are present together in the same composite particles 290. The composite particles may be formed by any suitable process, for example, the combustion catalyst may be deposited in and/or on desiccant particles, such as by ion exchange, wash coat, physical vapor deposition (PVD), chemical vapor deposition (CVD), or a combination thereof among others. Alternatively, or in addition, composite desiccant-catalyst particles may be constructed by mixing a desiccant and a combustion catalyst, such as by milling, with subsequent formation of particles from the mixture using a suitable binder, such as a clay binder.

The catalyst may be distributed substantially uniformly or nonuniformly within the dryer compartment/chamber 250 and/or with respect to the desiccant 35. If distributed nonuniformly, the density of the catalyst may vary radially and axially within the dryer compartment/chamber. More generally, the dispersion, activity, and/or shape of the catalyst may be engineered to distribute combustion more uniformly throughout the dryer, thereby reducing overheating of particular regions within the dryer and promoting spatially uniform water desorption.

Dryer 280, and any of the other dryers disclosed herein, may (but is not required to) include an external heater 292 and a dryer body 294 that includes desiccant 35. External heater 292, also termed an external heater assembly, may be operatively disposed to transfer heat 296 to dryer body 294, that is, the external heater may be disposed proximate to and/or in contact with dryer body 294 and particularly the housing 242 thereof. The external heater may, for example, be an electrical heater, a chemical heater (i.e., a heater that releases heat generated by a chemical reaction (e.g., a gas heater), or a combination thereof, among others.

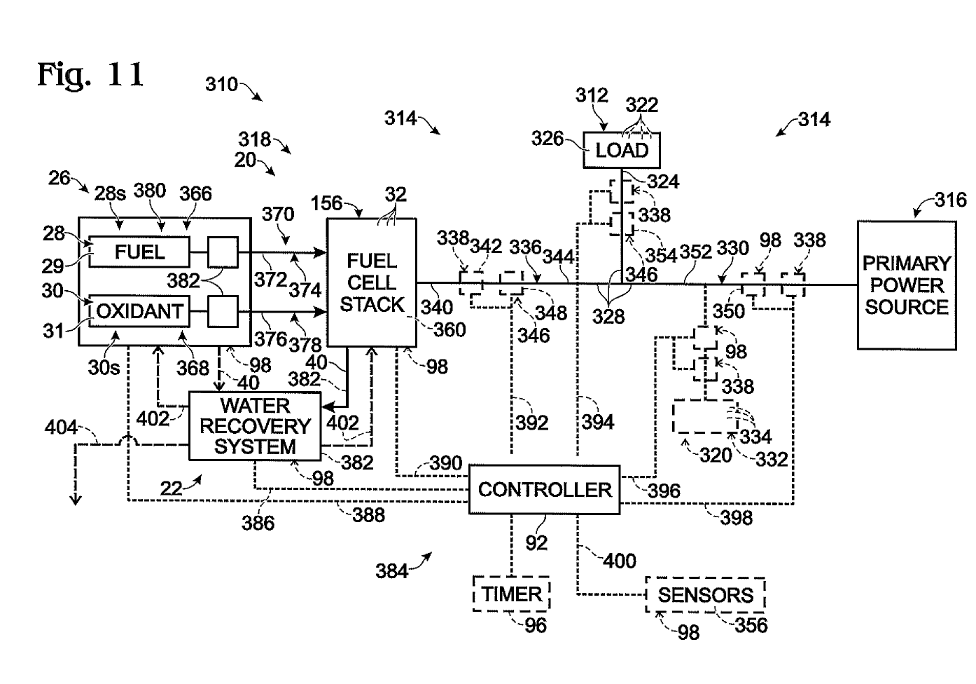

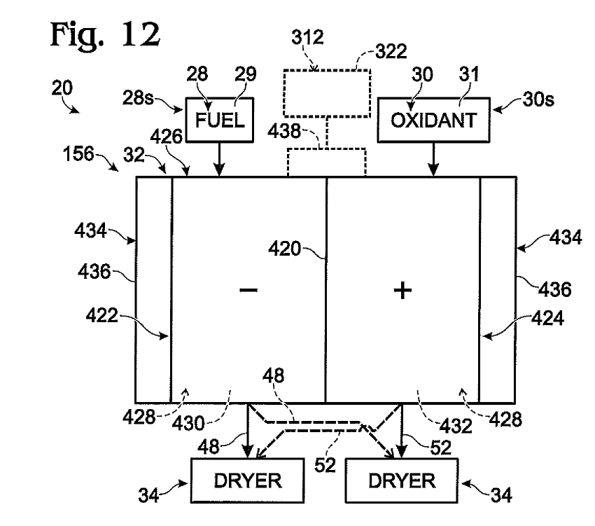

FIG. 11 shows an illustrative, non-exclusive example of a power delivery network 310 that incorporates at least one fuel cell system 20 according to the present disclosure. The network illustrates a non-exclusive example of how fuel cell system 20 may be integrated into a power delivery network and further illustrates additional aspects and features that optionally may be included in fuel cell system 20, whether or not the fuel cell system is being used as a primary power source or as a backup power source in power delivery network 310.

Power delivery network 310 may include an energy-consuming assembly 312 and an energy-producing system 314. The energy-producing system may include a primary power source 316, an auxiliary (or backup) power source 318 (e.g., fuel cell system 20), and, optionally, an energy-storage power source 320. In other examples, fuel cell system 20 may be the primary power source, and in such an embodiment the power delivery network may not include an auxiliary power source.

Power may be supplied to energy-consuming assembly 312 in any suitable form. For example, both the fuel cell system 20 and primary power source 316 may supply power as direct current (DC) or as alternating current (AC). As an illustrative, non-exclusive example, and for the purposes of illustration only, the primary power source may supply DC primary power at a voltage of fifty-four volts and the fuel cell system may supply DC power at the same or a different voltage.

Energy-consuming assembly 312 includes at least one energy-consuming device 322 and is adapted to be powered by energy-producing system 314, for example, by primary power source 316, fuel cell system 20, and/or energy-storage power source 320. Expressed in slightly different terms, energy-consuming assembly 312 includes at least one energy-consuming device 322 that is in electrical communication with the energy-producing system via load circuit 324. The energy-consuming assembly may be powered by only one power source at a time or may be powered, in part, by two or more power sources at the same time. When powered by two or more power sources at the same time, the collective power output may be delivered to the energy-consuming assembly, optionally with distinct subsets of energy-consuming devices 322 being powered by distinct power sources.

Energy-consuming device(s) 322 may be electrically coupled to primary power source 316, auxiliary power source 318 (fuel cell system 20), and/or to one or more optional energy-storage power sources 320 included in power delivery network 310. Device(s) 322 may apply a load 326 to a power source, such as fuel cell system 20, and may draw an electric current from the power source to satisfy the load. This load may be referred to as an applied load, and may include thermal and/or electrical load(s). It is within the scope of the present disclosure that the applied load may be satisfied by the fuel cell system 20, primary power source 316, and/or the energy-storage power source 320. Illustrative, non-exclusive examples of energy-consuming devices 322 may include wheeled vehicles (erg., cars, trucks, recreational vehicles, motorcycles, etc.), on-board vehicle components, aircraft, boats and other sea craft, lights and lighting assemblies, tools, appliances, computers, industrial equipment, signaling and communications equipment, radios, battery chargers, one or more households, one or more residences, one or more commercial offices or buildings, one or more neighborhoods, or any suitable combination thereof, among others.

The energy-consuming assembly is adapted to apply a load to energy-producing system 314. The load typically includes at least one electrical load. The primary power source is (nominally) adapted to satisfy that load (i.e., by providing a sufficient power output to the energy-consuming assembly), and the auxiliary power source is (nominally) adapted to provide a power output to at least partially, if not completely, satisfy the applied load when the primary power source is unable or otherwise unavailable to do so. These power outputs may additionally or alternatively be referred to herein as electrical outputs. The power and/or electrical outputs may be described as having a current and a voltage.

The energy-consuming assembly may be disposed in electrical communication with the primary and auxiliary power sources via any suitable power conduit(s), as schematically represented at 328 in FIG. 11. The primary power source and auxiliary power source may be described as having electrical buses in communication with each other and the energy-consuming assembly.

Energy-consuming assembly 312 may be adapted to be primarily, or principally, powered by primary power source 316. Primary power source 316 may be any suitable source of a suitable power output 330 for satisfying the applied load from the energy-consuming assembly. For example, primary power source 316 may include, correspond to, or be part of an electrical utility grid, another fuel cell system, a solar power system, a wind power system, a nuclear power system, a turbine-based power system, a hydroelectric power system, etc.

FIG. 11 schematically depicts that power delivery network 310 may, but is not required to, include at least one energy-storage power source 320, such as a battery assembly 332 of one or more batteries 334. The battery assembly may include any suitable type and number of cells, such as a plurality of batteries or cells arranged in series or in parallel, and may be referred to as a battery assembly that includes at least one battery 334 and an optional battery charger. When battery assembly 332 includes two or more batteries, the battery assembly may include, or be in electrical communication with, a rectifier or other suitable device for equalizing and/or normalizing the charge and/or electrical output of the batteries.

Energy-storage power source 320, when included, may be adapted to store at least a portion of the electrical output, or power output, 336 from fuel cell stack 156 of fuel cell system 20 or the power from the primary power source, such as to charge the batteries and/or equalize charges among and/or between batteries. Illustrative, non-exclusive examples of other suitable energy-storage devices that may be used in place of or in combination with one or more batteries include capacitors, ultracapacitors, and/or supercapacitors. Another illustrative example is a fly wheel. Energy-storage power source 320 may be configured to provide power to energy-consuming devices 322, such as to satisfy an applied load therefrom, when the fuel cell stack is not able to do so or when the fuel cell stack is not able to completely satisfy the applied load. Energy-storage power source 320 may additionally or alternatively be used to power the fuel cell system 20 during start-up of the fuel cell system.

Power delivery network 310 may, but is not required to, include at least one power-management module 338. Power-management module 338 includes any suitable structure or device(s) for conditioning or otherwise regulating the electrical output produced by primary power source 316, auxiliary power source 318, and/or energy-storage power source 320, and/or being delivered to/from energy-consuming devices 322. Power-management module 338 may include such illustrative, non-exclusive devices as buck and/or boost converters, rectifiers, inverters, power filters, relays, switches, or any combination thereof, among others. In some embodiments, the power delivery network may include at least one power-management module 338 operatively coupled to an output circuit 340 of the fuel cell system and including a voltage adjustment mechanism 342 for changing the output voltage 344 at which the fuel cell system is supplying (or attempting to supply) power to energy-consuming assembly 312 and/or energy-storage power source 320. Voltage adjustment mechanism 342 may be coupled to a control system of the fuel cell system, to control operation of the voltage adjustment mechanism.

Power delivery network 310 may, but is not required to, include one or more sensors 98. The sensors 98 may be configured to measure one or more electrical characteristics and/or non-electrical characteristics for any suitable portion of the network or the ambient environment. When present, sensors 98 may include one or more electrical sensors for measuring an electrical characteristic of the power delivery network. For example, the electrical sensor(s) may include an auxiliary output sensor 348 included in and/or operatively coupled to output circuit 340 for measuring an electrical characteristic of the fuel cell output. Alternatively, or in addition, the electrical sensors may include a primary output sensor 350 included in and/or operatively coupled to an output circuit 352 of the primary power source 316 for measuring an electrical characteristic of primary power output 330, and/or the electrical sensor(s) may include a load sensor 354 included in and/or operatively coupled to load circuit 66 for measuring an electrical characteristic of the load. The electrical sensor may measure any suitable electrical characteristic and/or combination of electrical characteristics, such as output current, voltage, resistance, impedance, and/or capacitance, among others.

The power delivery network 310 and/or fuel cell system 20 optionally may include one or more sensors 98 for measuring one or more other characteristics of the network 310, fuel cell system 20, or ambient environment and communicating these values to a controller. For example, sensor 98 may be an ambient temperature sensor 356 for measuring an ambient temperature. Alternatively, or in addition, sensor 98 may be a temperature sensor for measuring a temperature in or near the fuel cell system 20 (e.g., the temperature of the fuel cells 32 and/or of reactants (and/or the exhaust) upstream of and/or downstream from the fuel cell stack). Furthermore, sensor 98 may be at least one humidity sensor disposed in fuel cell stack 20 and/or downstream of the fuel cell stack in water recovery system 22. Illustrative temperature sensors that may be suitable include thermistors, thermocouples, infrared thermometers, electrical resistance thermometers, mercury-in-glass thermometers, silicon bandgap temperature sensors, coulomb blockade thermometers, and the like. Illustrative humidity sensors that may be suitable include hygrometers, impedance sensors, electrolytic sensors, color indicators, spectroscopic sensors, or the like.

Fuel cell system 20 may include at least one reactant delivery system 26 that is adapted to deliver reactants to fuel cells 32. The fuel cells, in turn, are adapted to produce an electric current from reaction of the reactants. The reactants generally include a fuel 28, such as hydrogen gas 29, and an oxidant 30, such as oxygen gas 31 (or air or another oxygen-containing gas that is suitable for use as an oxidant by the fuel cell stack).

Fuel 28 and oxidant 30 may be delivered to the fuel cells 32 from at least one fuel source, or fuel supply, 25 and at least one oxidant source, or oxidant supply, 27. The fuel cell system may be described as including a reactant delivery system 26 that is adapted to deliver streams of fuel and oxidant from the respective fuel and oxidant supplies, or sources. In some embodiments, the reactant delivery system and/or the fuel cell system may be described as including a fuel delivery system 366 and/or an oxidant delivery system 368. When the fuel is hydrogen gas and the oxidant is air, the fuel delivery system may be referred to as a hydrogen delivery system and the oxidant delivery system may be referred to as an air delivery system.

The reactant delivery system and/or fuel cell system may be described as including, and/or being in fluid communication with, a suitable conduit structure, or conduit assembly, 370. Conduit assembly 370 provides at least one fluid conduit through which fuel (such as hydrogen gas) may be delivered from the fuel source to the anode regions of the fuel cell stack, and at least one conduit through which air or other suitable oxidant may be delivered from the oxidant source to the cathode regions of the fuel cell stack.

The reactant delivery system and/or conduit assembly may have a power-generating configuration, such as schematically illustrated herein, with one or more fuel conduits, or fuel lines, 372 that carry a stream 374 of fuel 28 from fuel source 25 to anode regions of the fuel cells, and one or more oxidant conduits, or oxidant lines, 376 that carry a stream 378 of oxidant 30 from oxidant source 27 to the cathode regions of the fuel cells.

Fuel source 25 and oxidant source 27 each may include any suitable mechanism(s) for storing, generating, and/or supplying fuel 28 and oxidant 30. Each source may be a closed system that is hermetically sealed or may be an open system that is open to the ambient atmosphere (such as an air supply that draws air from the ambient atmosphere). If structured as a closed system, the fuel/oxidant source may (but is not required to) include a vessel, such as a tank, for containing the fuel (or a fuel feedstock) or oxidant. The vessel may be capable of withstanding an increased internal pressure, such that the contents of the vessel may be pressurized above atmospheric pressure. The vessel may have any suitable position relative to the fuel cell stack. For example, the vessel may be positioned to provide an internal source, that is, a fuel/oxidant source inside a housing that holds both the vessel and the fuel cell stack, or the vessel may be positioned in a spaced relation to the fuel cell stack to provide an external source. The external source may be nearby, for example, in the same room and/or building or on the same grounds as the fuel cell stack, or the external source may be remote from the fuel cell stack, such as a fuel (or oxidant) source operated by a municipal supplier or a power company.

Oxidant source 27 may include any suitable structure for providing a sufficient quantity of oxidant (e.g., oxygen, air, or other suitable oxidant) to the fuel cell stack at a suitable pressure for use in the fuel cell stack. In some embodiments, the oxidant source may include a drive mechanism for urging oxidant to the fuel cell stack. The drive mechanism may include or be a fan, a blower, a compressor, a pump, or a combination thereof, among others. In some embodiments, the oxidant source may be adapted to provide oxygen-enriched or nitrogen-depleted air to the fuel cell stack. In some embodiments, air for the fuel cell stack is drawn from the environment proximate the fuel cell stack, and in some embodiments, no drive mechanism is utilized to propel oxidant to the fuel cell stack (e.g., to provide an “open cathode,” or “air-breathing,” design). Non-exclusive examples of suitable sources 27 of oxygen gas 31 include a pressurized tank of oxygen, oxygen-enriched air, or air; or a fan, compressor, blower or other device for directing ambient air to the cathode regions of the fuel cells in the fuel cell stack.

Fuel source 25 may provide generation and/or storage of the hydrogen gas or other fuel in any suitable form. The fuel may be in a molecular form suitable for use in the fuel cell stack or may be in a precursor form (a feedstock) that is processed to produce the fuel by changing the molecular structure of the precursor form. If stored as fuel rather than as a feedstock, the fuel may be in an unbound form (e.g., as a gas or liquid) that is available on demand or may be in a bound (e.g., adsorbed) form that must be released in order to use the fuel in the fuel cell stack. Illustrative, non-exclusive examples of suitable fuel sources 25 for hydrogen gas 29 include a pressurized tank, a metal hydride bed or other suitable hydrogen storage device, a chemical hydride (such as a solution of sodium borohydride), and/or a fuel processor or other hydrogen-generation assembly 380 that produces a stream containing pure or at least substantially pure hydrogen gas from at least one feedstock.

In some embodiments, the fuel source may include a hydrogen-generation assembly 380 adapted to produce a product hydrogen stream containing hydrogen gas 29 as a majority component. For example, the product stream may contain pure or substantially pure hydrogen gas. The hydrogen-generation assembly may include a hydrogen-producing assembly, or fuel processing region, that includes at least one hydrogen-producing region in which hydrogen gas is produced from one or more feedstocks. The hydrogen-generation assembly also may include a feedstock delivery system that is adapted to deliver the one or more feedstocks to the hydrogen-producing region in one or more feed streams. The feedstock delivery system may be adapted to deliver the feed stream(s) at a suitable condition and flow rate for producing the desired flow of hydrogen gas therefrom. The feedstock delivery system may receive the feedstocks from a pressurized source and/or may include at least one pump or other suitable propulsion mechanism for selectively delivering the feedstock(s) under pressure to the hydrogen-generation assembly The hydrogen-producing region may be adapted to produce hydrogen gas as a primary, or majority, reaction product through any suitable chemical process or combination of processes.

Examples of suitable mechanisms for producing hydrogen gas from one or more feed streams include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock may be water. Illustrative, non-exclusive examples of suitable carbon-containing feedstocks include at least one hydrocarbon or alcohol. Illustrative, non-exclusive examples of suitable hydrocarbons include methane, propane, natural gas, diesel, kerosene, gasoline and the like. Illustrative, non-exclusive examples of suitable alcohols include methanol, ethanol, and polyols, such as ethylene glycol and propylene glycol. It is within the scope of the present disclosure that the fuel processor may be adapted to produce hydrogen gas by utilizing more than a single hydrogen-producing mechanism.

In many applications, it is desirable for hydrogen-generation assembly 380 to produce at least substantially pure hydrogen gas. Accordingly, the hydrogen-generation assembly may include one or more hydrogen-producing regions that utilize a process that inherently produces sufficiently pure hydrogen gas, or the hydrogen-generation assembly may include suitable purification and/or separation devices that remove impurities from the hydrogen gas produced in the hydrogen-producing region. As another example, the hydrogen-generation assembly may include purification and/or separation devices that are downstream from the hydrogen-producing region and adapted to reduce the concentration of one or more non-hydrogen components, or other gases, of the reaction product stream from the hydrogen-producing region. In the context of a fuel cell system, the hydrogen-generation assembly may be adapted to produce at least substantially pure hydrogen gas, or even pure hydrogen gas. For the purposes of the present disclosure, substantially pure hydrogen gas refers to hydrogen gas that is greater than 90% pure, and optionally greater than 95% pure, greater than 99% pure, or greater than 99.5% pure. Illustrative, non-exclusive examples of suitable fuel processors are disclosed in U.S. Pat. Nos. 6,221,117, 5,997,594, 5,861,137, and U.S. Patent Application Publication Nos. 2001/0045061, 200310192251, and 2003/0223926. The complete disclosures of the above-identified patents and published patent applications are hereby incorporated by reference.

Reactant delivery system 26 and water recovery system 22 may include any suitable flow-management devices 382, which may be mechanism(s) and/or structure(s) for carrying, guiding, regulating flow of, and/or driving fluid flow via conduit assembly 370 or conduit assembly 40, respectively. Each conduit assembly may include any suitable combination of conduits, valves, and/or drive mechanisms (to drive valve operation and/or fluid flow), among others. Each flow-management device may be operable manually (i.e., requiring human effort or action), automatically (i.e., by machine without the need for triggering or implementing human effort or action), or both. If configured for manual operation, the flow-management device may be configured to be operated by hand or by a drive mechanism that is controlled by direct human action. Each flow-management device 382 may be structured to exert any suitable effect on the flow rate and/or flow direction of a fluid stream (e.g., fuel stream, oxidant stream, anode exhaust stream, cathode exhaust stream, etc.) between its source and target. Accordingly, each flow-management device 382 may function to increase or decrease the corresponding fluid flow rate and/or to start or stop fluid flow. Alternatively, or in addition, each flow-management device 382 may function to divert flow of a fluid stream to a distinct flow path. Illustrative flow-management devices may include a valve and/or a drive mechanism Any suitable type of valve may be used, such as stopcock, bleed, needle, shut-off, pinch, angle, ball, check (to restrict reverse flow), butterfly, diaphragm, flipper, solenoid, globe, slide, gate, or the like.

Fuel cell systems 20 and/or power delivery networks 310 according to the present disclosure may, but are not required to, also include a control system 384. Control system 384 may include at least one controller 92 that controls the operation of the fuel cell system 20 and/or power delivery network 310, such as by monitoring and/or controlling the operation of various components and/or monitoring and/or controlling various operating parameters of fuel cell system 20 and/or power delivery network 310. The controller also may be termed a digital processor or a computing device, among others, and may include data storage and software, firmware, and/or hardware components.

The control system may include any suitable number and type of communication links for receiving input signals and for sending output signals (e.g., command signals). For the purpose of schematic illustration, controller 92 is shown in FIG. 11 in communication, via respective communication links 386-400, with water recovery system 22, reactant delivery system 26, fuel cells 32, and each of the power-management modules 338 and sensors 98. However, each of these communication links is optional and thus power delivery network 310 and/or fuel cell system 20 may be configured to have any suitable subset of the communication links depicted here. The control system may be in communication via link 386 with any suitable number and type of sensors 98 of water recovery system 22, such as one or more humidity sensors.

Communication between control system 384 and any portion of power delivery network 310 may be mostly or exclusively one-way communication or may include at least two-way communication. In some embodiments, the control system 384 may include a plurality of controllers 92 in communication with each other. For example, one of the controllers may be a primary, or central, controller that coordinates and controls the activity of one or more (or all) other controllers. Coupling and/or communication between the controllers and/or between a controller and each other fuel cell system 20 and/or power delivery network 310 component may be wired or wireless for each coupling and thus may be electrical (e.g., conductive), electromagnetic (e.g., inductive and/or capacitive coupling), optical, and/or the like.

The control system may automate and/or control any suitable aspects of fuel cell system operation. For example, the control system may control (1) fuel processing and/or fuel generation, (2) delivery of fuel and/or oxidant to the fuel cell stack and thus production of electrical output and emission of effluent from the reactant delivery system and/or fuel cell stack, (3) binding (sorption) of water from fluid streams by determining the fluid stream(s) that flows to each dryer, (4) release of bound water by actuating generation of heat that causes water desorption, such as by actuating introduction of a combustible mixture into the dryer, (5) processing of released water, or any combination thereof among others. Accordingly, the control system may automate water recovery from at least one effluent stream, and, optionally, may automate collection and/or reuse of recovered water. Further optional aspects of methods that may be performed by the control system of fuel cell system 20 and/or power delivery network 310 are described elsewhere in the present disclosure, such as in relation to FIGS. 1 and 2.

The controller's operations, such as the command signals generated therefrom, may be provided by or otherwise correspond to an algorithm for determining when and how water recovery system 22 should be operated for water recovery. The algorithm may consider electrical output, volume of supplied fuel, humidity of an inflow or outflow stream (e.g., between the fuel cells and the dryer(s) and/or downstream of the dryer(s)), or any combination thereof, among others.

Water recovery system 22 may have any suitable fluidic connections to other components of power delivery network 310. For example, water recovery system 22 may receive one or more fluid streams from reactant delivery system 26 and/or fuel cell stack 156 via conduit assembly 40. The water recovery system also may emit one or more fluid streams 402 that return recovered water, as water vapor and/or liquid water, to reactant delivery system 26 and/or fuel cell stack 156, among others, for reuse of the recovered water by the fuel cell system 20 and/or power delivery network 310. The water recovery system alternatively or additionally may provide an exit path 404 by which recovered water can be removed from the fuel cell system 20 and/or power delivery network 310 by fluid flow and/or a removable vessel.

Fuel cell system 20 may include any other suitable components. For example, fuel cell system 20 also may, but is not required to, include a thermal management system. The thermal management system may be adapted to regulate the temperature of any suitable portion of fuel cell system 20, for example, maintaining the fuel cell stack within a predetermined, or selected, operating temperature range, such as below a maximum threshold temperature, and/or above a minimum threshold temperature. The thermal management system thus may include a cooling mechanism and/or a heating mechanism. For example, the thermal management system may utilize a fluid that is propelled around a flow circuit by a pump. The fluid may flow through and/or around fuel cells 32, to provide cooling and/or heating of the fuel cells. The flow circuit may (but is not required to) include a thermostatic valve that operates to direct the fluid into the proximity of the cooling/heating mechanism, for heat transfer, or to divert the fluid away from the cooling/heating mechanism via a detour, according to the temperature of the fuel cells and/or the fluid. Any suitable cooling mechanism and/or heating mechanism may be used in the fuel cell system. For example, the cooling mechanism may include a radiator and at least one fan. In other embodiments, the cooling mechanism may include a refrigerating compressor, a Peltier device, a fan or blower, etc. Illustrative heating mechanisms may include a resistive heater, a combustion heater (e.g., a gas heater), an infrared lamp, a Peltier device, or the like. The temperature of the thermal control system may be measured by a temperature sensor. An illustrative, non-exclusive example of suitable thermal management systems are disclosed in U.S. Patent Application Publication No. 2007/0042247, the complete disclosure of which is hereby incorporated by reference. Additional illustrative, non-exclusive examples of auxiliary fuel cell systems, and components and configurations therefor, are disclosed in U.S. Patent Application Publication No. 2004/0247961, the complete disclosure of which is hereby incorporated by reference.

Fuel cell system 20 may include a fuel cell stack 156 that includes at least one fuel cell 32, and typically, a plurality of fuel cells 32. The fuel cells may be electrically connected to one another, such as in a series, and mechanically connected to provide fluid communication between the fuel cells. Although not required by all embodiments, the fuel cells may be arranged face-to-face with one another, and in one stack or two or more adjacent stacks, or, for example, in more complex geometrical arrangements.

The fuel cell stacks of the present disclosure may utilize any suitable type of fuel cell, including but not limited to fuel cells that receive hydrogen gas and oxygen gas as proton sources and oxidants. An illustrative, non-exclusive example of such a fuel cell is a proton exchange membrane (PEM), or solid polymer, fuel cell, although the water recovery systems and methods of the present disclosure may be used with other types of fuel cells, such as alkaline fuel cells, phosphoric acid fuel cells, solid oxide fuel cells, molten carbonate fuel cells, or the like. For the purpose of illustration, an illustrative fuel cell 32 in the form of a proton exchange member (PEM) fuel cell is schematically illustrated in FIG. 12.

Each fuel cell 32 may be structured to generate an electrical potential using discrete regions separated by a divider, or electrolytic barrier, 420 (which also may be referred to as an electron barrier). For example, the fuel cell may include an anode IS region 422 (the anode regions are collectively indicated schematically by “−”) and a cathode region 424 (the cathode regions are collectively indicated schematically by “+”), with respective negative and positive electrical biases or charges during fuel cell operation. Electrolytic barrier 420 may act to divide the fuel cell 32 such that the fuel and the oxidant do not freely mix with one another, while permitting selective movement of positive charge through the barrier (and thus acting as an electron barrier). The barrier restricts contact, particularly substantial contact of the fuel and oxidant, meaning that the fuel and the oxidant remain (mostly) separated from each other. However, while not necessarily desired or required by all embodiments, in some embodiments the electrolytic barrier may permit a minor amount of leakage of the fuel and/or oxidant across the barrier while still serving as a barrier. The electrolytic barrier may be structured as a sheet- or membrane-supported electrolyte, for example, a proton exchange membrane 420 that permits passage of protons while blocking passage or flow of electrons, and as such may also be described as an ion exchange membrane.

Proton exchange membrane fuel cells typically utilize a membrane-electrode assembly 426 consisting of an ion exchange, or electrolytic, membrane 420 located between an anode region 422 and a cathode region 424. Each region 422 and 424 includes an electrode 428, namely, an anode 430 and a cathode 432, respectively. Each region 422 and 424 also includes a support 434, such as a supporting plate 436. Support 434 may form a portion of a bipolar plate assembly. The supporting plates 436 of fuel cell 32 may carry, or conduct, the relative voltage potential produced by the fuel cell.

In operation, hydrogen gas 29 from fuel supply 25 is delivered to the anode region, and air (and/or oxygen) 31 from oxidant supply 31 is delivered to the cathode region. Hydrogen gas and oxygen gas may be delivered to the respective regions of the fuel cell via any suitable mechanism from respective supplies 25 and 31.

Hydrogen gas and oxygen gas typically react with one another via an oxidation-reduction reaction. Although electrolytic membrane 420 restricts the passage of a hydrogen molecule (a fuel molecule), it will permit a hydrogen ion (proton) to pass through it, largely due to the ionic conductivity of the membrane. The free energy of the oxidation-reduction reaction drives the proton from the hydrogen gas through the barrier. As membrane 420 also tends not to be electrically conductive, an external circuit 438 is the lowest energy path for the remaining electron. In cathode region 424, electrons from the external circuit and protons from the membrane combine with oxygen to produce water and heat.

Also shown in FIG. 12 are an anode exhaust stream 48, which may contain hydrogen gas, and a cathode air exhaust stream 52, which is typically at least partially, if not substantially, depleted of oxygen gas. Anode exhaust stream 48 may also include other components, such as nitrogen gas, water, and other gases that are present in the hydrogen gas or other fuel stream that is delivered to the anode region. Cathode exhaust stream 52 will typically also include water. Fuel cell stack 156 may include a common hydrogen (or other reactant/fuel) feed, air intake, and stack exhaust streams, and accordingly may include suitable fluid conduits to deliver the associated streams to, and collect the streams from, the individual fuel cells. It is also within the scope of the present disclosure that the hydrogen gas stream that is delivered to the anode region as a fuel stream may be (but is not required to be) recycled (via any suitable mechanism and/or via a suitable recycle conduit from the anode region) to reduce the amount of hydrogen gas that is wasted or otherwise exhausted in anode exhaust stream 48. As an illustrative, non-exclusive example, the hydrogen gas in the anode region may be recycled for redelivery to the anode region via a recycle pump and an associated recycle conduit. In such an embodiment, the recycle pump may draw hydrogen gas from the anode region of a fuel cell (or fuel cell stack) and redeliver the recycled hydrogen gas via the recycle conduit to the anode region of the fuel cell (and/or a different fuel cell or fuel cell stack).

In practice, fuel cell stack 156 may include a plurality of fuel cells 32 with bipolar plate assemblies or other suitable supports separating adjacent membrane-electrode assemblies. The supports may permit the free electrons to pass from the anode region of a first cell to the cathode region of the adjacent cell via the bipolar plate assembly, thereby establishing an electrical potential through the stack. This electrical potential may create a net flow of electrons that produces an electric current, which may be used to satisfy an applied load, such as from an energy-consuming device(s) 322.

### INDUSTRIAL APPLICABILITY

The fuel cell systems disclosed herein are applicable to the energy-production industries, and more particularly to the fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of recovering water in a fuel cell system, comprising:
emitting effluent from one or more fuel cells that are producing electrical output from a supplied fuel and an oxidant;
binding water from at least a portion of the effluent with a desiccant;
releasing bound water from the desiccant in a pulsatile fashion by periodically heating the desiccant; and
processing at least a portion of the bound water that is released from the desiccant.

2. The method of claim 1, wherein the step of processing includes a step of collecting, in liquid form, at least a portion of the bound water that is released from the desiccant.

3. The method of claim 1, wherein the step of processing includes a step of reusing, as water vapor in the fuel cell system, at least a portion of the bound water that is released from the desiccant.

4. The method of claim 1, wherein the step of binding water includes a step of at least one of adsorbing water with the desiccant and absorbing water from the desiccant.

5. The method of claim 1, wherein the step of releasing bound water includes a step of periodically heating the desiccant with heat generated at least in part by a combustion process.

6. The method of claim 5, wherein the step of periodically heating the desiccant includes a step of periodically heating the desiccant with heat generated at least in part by combustion of an exhausted fuel received from the fuel cells.

7. The method of claim 6, wherein the step of periodically heating the desiccant includes a step of contacting a combustion catalyst with the exhausted fuel, and wherein the combustion catalyst is configured to catalyze combustion of the exhausted fuel.

8. The method of claim 7, wherein the step of contacting is performed with the catalyst intermixed with the desiccant, with the catalyst disposed at least partly upstream of the desiccant, or both.

9. The method of claim 1, wherein the step of releasing bound water includes a step of periodically energizing at least one electrical heating assembly to heat at least one of a combustion catalyst and the desiccant.

10. The method of claim 6, wherein the step of releasing bound water includes a step of reacting an oxidant with the exhausted fuel emitted by the fuel cells, and wherein the step of releasing bound water is performed at least partly upstream of the desiccant, at least partly with the desiccant in contact with the exhausted fuel, or both.

11. The method of claim 6, wherein the step of emitting effluent includes a step of forming one or more effluent streams, wherein at least one of the effluent streams carries at least a portion of the exhausted fuel, wherein the step of releasing bound water includes a step of combining (1) the at least one effluent stream that carries the at least a portion of the exhausted fuel and (2) an oxidant stream from a source other than the one or more fuel cells, and wherein the step of combining is performed upstream of at least a portion of the desiccant.

12. A method of recovering water in a fuel cell system, comprising:
emitting effluent from one or more fuel cells that are producing electrical output from a supplied fuel and an oxidant;
binding water from at least a portion of the effluent with a desiccant; and
releasing bound water from the desiccant with heat generated at least in part by combustion of an exhausted fuel emitted by the fuel cells.

13. The method of claim 12, wherein the step of emitting effluent includes a step of emitting an anode exhaust and a cathode exhaust from the one or more fuel cells, wherein the exhausted fuel is provided by the anode exhaust, and wherein the step of binding water includes a step of binding water from at least a portion of the anode exhaust, at least a portion of the cathode exhaust, or both.

14. The method of claim 13, wherein the step of binding water includes a step of separately contacting the desiccant with anode exhaust and cathode exhaust, and wherein the step of releasing bound water includes a step of contacting the desiccant with a mixture of anode exhaust and cathode exhaust.

15. The method of claim 12, wherein the step of releasing bound water includes a step of contacting a combustion catalyst with the exhausted fuel to generate heat for heating the desiccant.

16. A fuel cell system with water recovery, comprising:
one or more fuel cells configured to generate electrical output from a supplied fuel and an oxidant while emitting effluent, the effluent providing an exhausted fuel; and
at least one dryer fluidly coupled to the one or more fuel cells and configured to receive at least a portion of the effluent, the at least one dryer including a desiccant configured to bind water from the portion of the effluent and also including a catalyst configured to catalyze combustion of the exhausted fuel to generate heat that releases bound water from the desiccant.

17. The fuel cell system of claim 16, wherein the effluent includes an anode exhaust stream and a cathode exhaust stream, wherein the anode exhaust stream provides the exhausted fuel, and wherein the at least one dryer is configured to receive at least a portion of the anode exhaust stream and at least a portion of the cathode exhaust.

18. The fuel cell system of claim 16, wherein the desiccant includes at least one of an adsorbent material for adsorbing water from the effluent and an absorbent material for absorbing water from the effluent.

19. The fuel cell system of claim 16, wherein the catalyst is disposed at least partly upstream of the desiccant.

20. The fuel cell system of claim 16, wherein the catalyst and the desiccant are intermixed.

21. The fuel system of claim 16, wherein the desiccant and the catalyst are in contact with one another.

22. The fuel system of claim 16, wherein the at least one dryer further includes at least one electrical heater assembly.

23. The fuel cell system of claim 16, further comprising a controller configured to periodically actuate introduction of a combustible mixture into the at least one dryer.

24. The fuel cell system of claim 23, wherein the at least one dryer includes a first dryer and a second dryer, and wherein the controller is configured to alternately actuate introduction of a combustible mixture into the first dryer and the second dryer.

25. The fuel cell system of claim 16, further comprising a water collection assembly disposed downstream of the at least one dryer and including a condenser assembly configured to condense water received from the at least one dryer and also including a vessel configured to receive and store the water that is condensed by the condenser assembly.
